(19) United States
(12) Patent Application Publication
(10) Pub. No.: US 2010/0021653 A1
(43) Pub. Date: Jan. 28, 2010

(54) METHOD OF FORMING ELECTRICAL TRACES ON SUBSTRATE

(75) Inventors: CHENG-HSIEN LIN, Tayuan (TW); YAO-WEN BAI, Shenzhen City (CN); QIU-YUE ZHANG, Shenzhen City (CN); RUI ZHANG, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: FUKUI PRECISION COMPONENT (SHENZHEN) CO., LTD., Shenzhen City (CN); FOXCONN ADVANCED TECHNOLOGY INC., Tayuan (TW)

(21) Appl. No.: 12/330,577

(22) Filed: Dec. 9, 2008

(30) Foreign Application Priority Data
Jul. 25, 2008 (CN) 200810303086.X

(51) Int. Cl. C08J 7/18

(52) U.S. Cl. 427/553

(57) ABSTRACT

An exemplary method for forming electrical traces on a substrate includes flowing steps. Firstly, a circuit pattern is formed on the substrate by printing a silver ions-containing ink. The ink comprises an aqueous carrier medium, and a silver halide emulsion soluble in the aqueous carrier medium. Secondly, an irradiation ray irradiates the circuit pattern to reduce the silver ions into silver to form a silver particle circuit pattern comprised of silver particles. Thirdly, a metal overcoat layer is electroless-plated on the silver particle circuit pattern thereby obtaining electrical traces.

### CROSS-REFERENCE TO RELATED APPLICATIONS

This application relates to commonly-assigned copending applications Ser. No. 12/235994, entitled “METHOD OF FORMING CIRCUITS ON CIRCUIT BOARD”, Ser. No. 12/253869, entitled “PALLADIUM IONS-CONTAINING INK AND METHOD OF FORMING ELECTRICAL TRACES USING THE SAME”, and Ser. No. 12/327621, entitled “INK AND METHOD OF FORMING ELECTRICAL TRACES USING THE SAME”. Disclosures of the above-identified applications are incorporated herein by reference.

### BACKGROUND

1. Technical Field

The present disclosure relates generally to a method of forming electrical traces, and particularly, to a method of forming electrical traces containing silver on a substrate using ink jet printing method.

2. Description of Related Art

A method for forming circuits (or electrical traces) on a substrate in printed circuit boards and semiconductor chips using ink jet printing is becoming more and more popular. Ink jet printing is a non-impact dot-matrix printing process in which droplets of ink are jetted from a small aperture directly to a specified area of a medium to create an image thereon.

A typical ink jet printing method for manufacturing circuits is disclosed, in which an ink containing nano-scale metal particles is applied by an ink jet printer onto a surface of a substrate to form a pattern. The nano-scale metal particles pattern is then heat-treated (such as sintered) at a temperature of about 200 to 300 degrees Celsius. In such a manner, the disperser covering the nano-scale metal particles is removed, and then the nano-scale metal particles are meanwhile molten to form a continuous electrical trace with good conductivity. However, in the heat treatment process, the high temperature (e.g. 200 to 300 degrees Celsius) can soften and melt the substrate due to a poor heat-resistant of the substrate, thereby, damaging the substrate. Therefore, the ink containing nano-scale metal particles is not suitable for ink jet circuits printing process.

What is needed, therefore, is an ink and a method of forming electrical traces by use of the ink which can overcome the above-described problems.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a flowchart of a method for forming electrical traces on a substrate, according to an exemplary embodiment.

FIG. 2 to FIG. 5 are schematic, cross-sectional views showing each step of the method described in FIG. 1.

### DETAILED DESCRIPTION OF THE EMBODIMENTS

Reference will now be made to the drawings to describe an exemplary embodiment of the method of forming electrical traces on a substrate in detail.

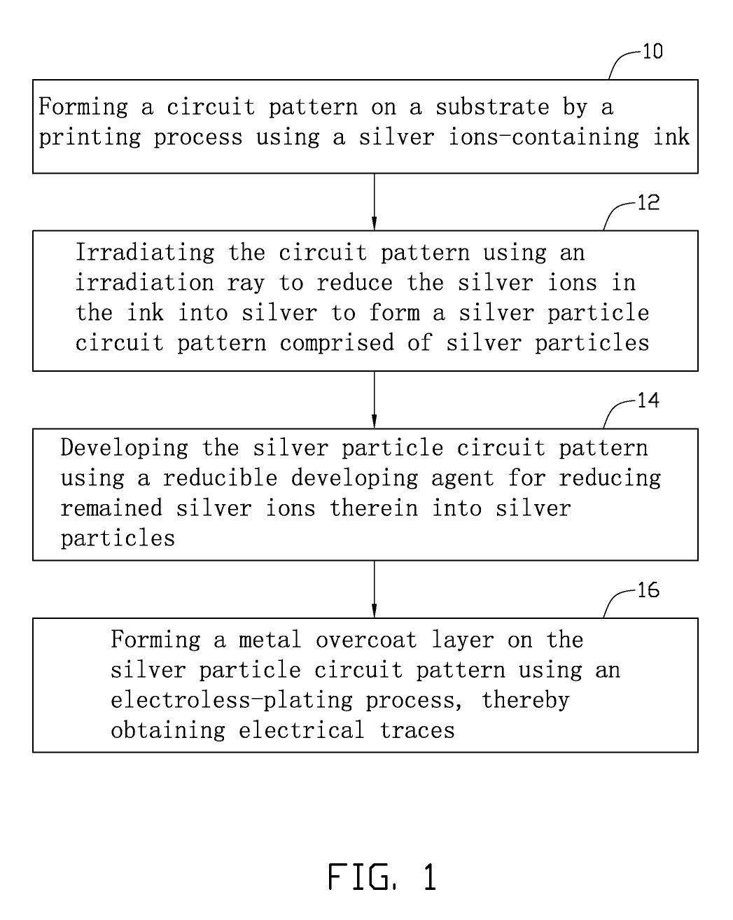

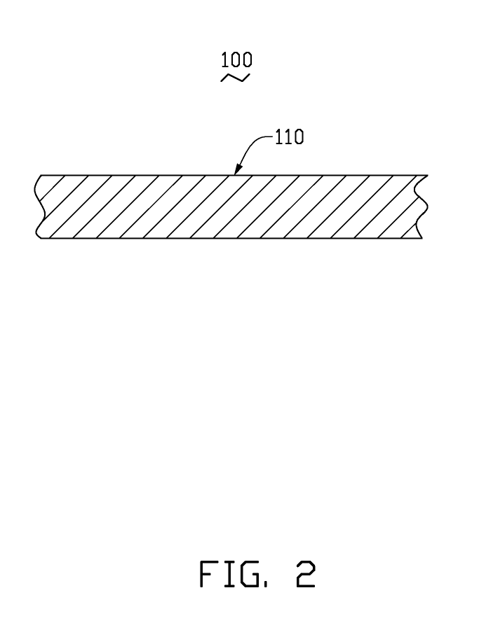

Referring to FIG. 1, an exemplary embodiment of a method of forming electrical traces on a substrate is illustrated. The method will be described in detail with reference to FIG. 2 to FIG. 5.

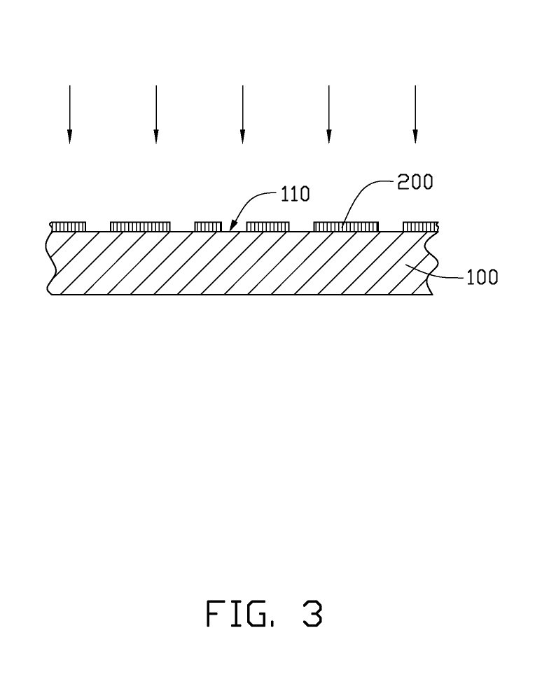

In step 10, referring to FIGS. 2 and 3, a circuit pattern 200 made of a silver ions-containing ink is formed on a substrate 100.

With reference to FIG. 2, the substrate 100 is comprised of a material suitable for making printed circuit boards or semiconductor chips, such as polyimide (PI), polyethylene terephthalate (PET), polyarylene ether nitrile (PEN), etc. The substrate 100 has a surface 110. To improve an bonding strength between the circuit pattern 200 and the surface 110, the surface 110 can be processed using surface treating methods, e.g., a washing process, a micro-etching process, to remove pollutants, oil, grease, or other contaminates from the surface 110 of the substrate 100.

The silver ions-containing ink includes an aqueous carrier medium and a silver halide emulsion uniformly dissolved in the aqueous carrier medium. Optionally, the aqueous carrier medium can further include water or a mixture of water and at least one water soluble organic solvent. For example, water-soluble organic solvents may be selected from the group consisting of alcohols, ketones or ketoalcohols, ethers, esters, and polyhydric alcohols.

In the illustrated embodiment, a dual implantation method is applied to prepare the silver halide emulsion such as a AgBrI emulsion, which will be described as following.

Firstly, dual implantation of 1.2 mol AgNO₃ solution and 1.2 mol KBrI solution simultaneously into gelatin in a amount of 5 weight percent with thorough stirring, is performed at a temperature in a range from about 25 degrees Celsius to about 35 degrees Celsius for about 5 minutes to about 15 minutes. The AgNO₃ solution reacts with the KBrI solution in the gelatin to form AgBrI emulsion preform. An equal speed dual implantation is employed in this case to increase a uniformity of mixing during the dual implantation.

Secondly, the gelatin is continuously added to a combination formed by the dual implantation so that sedimentation of the AgBrI emulsion preform occurs. A product from the sedimentation is cleaned and re-dissolved, thereby obtaining the AgBrI emulsion (e.g. the silver halide emulsion).

Eventually, the silver halide emulsion is dissolved in the aqueous carrier medium to prepare the silver ions-containing ink. It is known that the silver halide emulsion has a better dispersive ability because the gelatin used to prepare the silver halide emulsion is a good dispersion agent. In addition, the silver halide emulsion is sensitive. Thus, to avoid deterioration of the ink, a dark environment is preferred to preserve the ink.

Additionally, to improve a bonding strength between the ink and the substrate 110, a surface-active agent, a viscosity modifier, a binder, a humectant or mixtures thereof can be selectively added into the ink to adjust viscosity, surface tension, and stability of the ink. The surface-active agent can be anionic, cationic or non-ionic surface-active agent. The binder material can be polyurethane, polyvinyl alcohol or macromolecule polymer.

In the ink of the illustrated case, a content of the binder is in a range from 0.1 to 20 weight percent, a content of the viscosity modifier is in a range from 0.1 to 50 weight percent, a content of the surface-active agent is in a range from 0.1 to 5 weight percent. Percents are based on the total weight of the ink.

Referring to FIG. 3, the circuit pattern 200 is formed on the surface 110 using an ink jet printing method. In an ink jet printing process, the silver ions-containing ink of the present embodiment, which includes the sliver halide emulsion, is used with an ink jet printer to form the circuit pattern 200. In the process of forming the circuit pattern 200, a nozzle of the ink jet printer is disposed close to the surface 110, and the ink is ejected from the nozzle and deposited on the surface 110 to form a desired pattern, i.e., the circuit pattern 200. The circuit pattern 200 is formed by the ink. As mentioned above, the silver ions are uniformly dispersed in the ink. Thus, the circuit pattern 200 has a uniform thickness and width on the surface 110.

Compared with the nano-scale metal particles, the silver halide emulsion for providing the silver ions in the ink have an excellent dispersive ability, which can efficiently prevent aggregation of the nano-scale metal particles. Therefore, the silver ions are uniformly dispersed for achieving the electrical traces with uniform thickness and width.

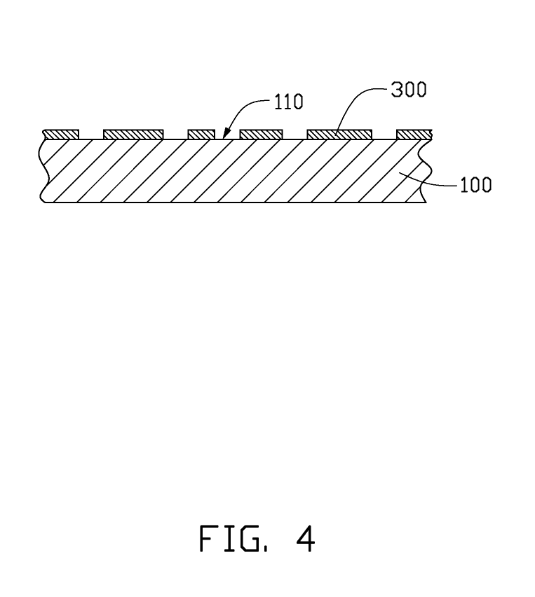

Continuing to step 12, referring to FIGS. 3 and 4, an irradiation ray irradiates the circuit pattern 200 for reducing the silver ions in the ink into silver particles, thus the circuit pattern 200 is converted or transformed into a silver particle circuit pattern 300 comprised of the silver particles. The irradiation ray can be chosen from any ray such as ultraviolet ray, laser and γ radiation. The irradiating time is generally from about 1 minute to about 15 minutes to shorten a manufacturing circle time of the silver particle circuit pattern 300. In addition, the irradiation ray and the irradiating time can vary according to the reducing agent.

A reaction principle of irradiating the silver halide emulsion is explained as below. Each of the halide ions (e.g. iodine and bromine ions) contained in the silver halide emulsion (e.g. AgBrI emulsion) loses a electron to form a corresponding halide atom, and each of the silver ions (e.g. silver ions) contained therein correspondingly obtains the electron formed from the halide ions to form a corresponding silver atom, thereby forming the silver particles.

To substantially reduce the silver ions in the silver particle circuit pattern 300 into the silver particles, a developing process (shown in the step 14 of FIG. 1) is employed to develop the irradiated silver particle circuit pattern 300, thereby efficiently plating the metal layer on the silver particle circuit pattern 300. It is understood that the developing process can also be omitted depending on practical requirements. The developing process is described in next paragraph in detail.

The irradiated silver particle circuit pattern 300 is dipped into a developing agent with reducibility to create an oxidation reduction reaction between the silver ions thereof and the developing agent to obtain the silver particle. The developing agent can be methyl-p-aminophenol sulfate or hydroquinone. In the present embodiment, the methyl-p-aminophenol sulfate is employed as the developing agent. It is better that sodium sulfite is added into the developing agent for preventing the methyl-p-aminophenol sulfate from being oxidized. To accelerate the oxidation reduction reaction, a promoter can also be added into the developing agent. The promoter can be selected from the group consisting of soft alkaline such as potassium carbonate and sodium carbonate having PH value of 10.8, weak alkaline such as borax, and strong alkaline such as sodium hydroxide and potassium hydroxide.

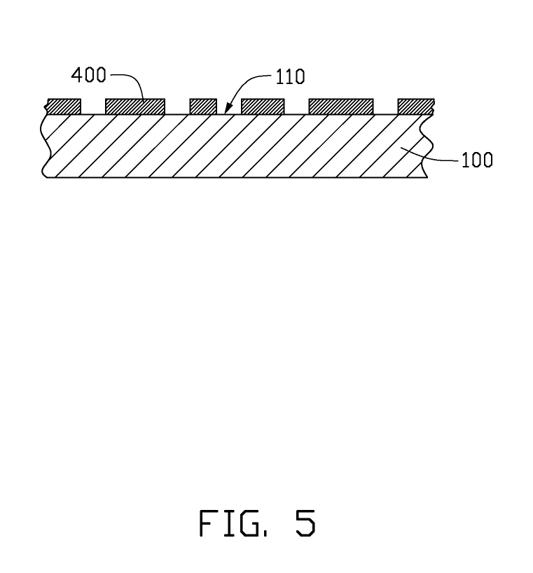

In step 16, as shown in FIG. 5, a metal overcoat layer is plated on the silver particle circuit pattern 300 to form a number of electrical traces 400 using an electro-plating method. Generally, the silver particle circuit pattern 300 comprised of a number of silver particles has a low electrical conductivity due to its incompact structure. Thus, a metal overcoat layer is further plated on the silver particle circuit pattern 300 to improve an electrical conductivity of the electrical traces 400.

In the plating process for the electrical traces 400, each of the silver particles in the silver particle circuit pattern 300 is a reaction center, and metal of the metal overcoat layer encapsulates each of the silver particles. Spaces between adjacent silver particles are entirely filled with the metal. Therefore, the silver particles of the circuit pattern 300 are electrically connected to each other by the metal, thereby improving the electrical conductivity of the electrical traces 400.

In the present embodiment, the metal overcoat layer comprised of copper is formed by an electroless-plating method on the silver particle circuit pattern 300. In detail, the silver particle circuit pattern 300 is dipped into an electroless-plating solution comprising a plurality of copper ions at 50 degrees Celsius for 2 minutes. Copper particles are deposited in the spaces between adjacent silver particles thereby forming the electrical traces 400, in which the silver particles are electrically connected to each with the copper particles. Average particle size of the copper particles is in a range from about 50 nanometers to about 150 nanometers.

Moreover, the electroless-plating solution may further include other materials, such as a copper compound, a reducing agent and a complex agent. The copper compound may be copper sulfate, copper chloride and other copper ion-containing compounds. The reducing agent may be methanol or glyoxylic acid. The complex agent may be potassium sodium tartrate or ethylene diamine tetraacetic acid disodium salt. The electroless-plating solution can also include a stabilizing agent, a surface-active agent and a brightening agent therein for meeting practical electroless-plating requirement. The electroless-plating solution of the present embodiment includes 10 g/L of copper sulfate, 22 g/L of potassium sodium tartrate, 50 g/L of ethylene diamine tetraacetic acid disodium salt, 15 mL/L of formaldehyde and 10 mL/L of methanol. A term “g/L” is used herein to refer to a weight percent of a solute (i.e. the copper sulfate, the potassium sodium tartrate and the ethylene diamine tetraacetic acid disodium salt) based on a total volume of the electroless-plating solution. Similarly, a term “mL/L” is applied herein to refer to volume percent of a solvent (i.e. the formaldehyde and the methanol) based on a total volume of the electroless-plating solution.

The surface 110 of the substrate 100 forming the electrical traces 400 is used to manufacture electrical device, for example, printed circuit boards and semiconductor chips. The method of the present embodiment provides a combination of chemical reaction and plating methods, instead of a high temperature sintering to connect nano-scale metal particles with each other. Therefore, the method improves continuity and electro-conductivity of electrical traces 400, and avoids the difficulty of controlling temperature during a sintering process.

While certain embodiments have been described and exemplified above, various other embodiments from the foregoing disclosure will be apparent to those skilled in the art. The present disclosure is not limited to the particular embodiments described and exemplified but is capable of considerable variation and modification without departure from the scope of the appended claims.

What is claimed is:

1. A method for forming electrical traces on a substrate, comprising:
forming a circuit pattern on a substrate by a printing process using a silver ions-containing ink, the ink comprising
an aqueous carrier medium; and
a silver halide emulsion soluble in the aqueous carrier medium;
irradiating the circuit pattern using an irradiation ray to reduce the silver ions in the ink into silver to form a silver particle circuit pattern comprised of silver particles; and
forming a metal overcoat layer on the silver particle circuit pattern using an electroless-plating process, thereby obtaining electrical traces.

2. The method as claimed in claim 1, wherein the metal overcoat layer is comprised of copper.

3. The method as claimed in claim 1, wherein an electroless-plating solution used in the electroless-plating process contains copper sulfate, potassium sodium tartrate, ethylene diamine tetraacetic acid disodium salt, formaldehyde and methanol.

4. The method as claimed in claim 1, wherein the silver halide emulsion is prepared using a dual-implantation method.

5. The method as claimed in claim 4, wherein the dual-implantation method comprises: dual-implanting AgNO₃ and KBrI into gelatin to form a combination;
substantially stirring the combination and creating a reaction between AgNO₃ and KBrI in the combination to form a AgBrI emulsion preform;
continuously adding the gelatin into the AgBrI emulsion preform to create a sedimentation of the combination thereby forming a deposition; and
washing and re-dissolving the deposition in the gelatin thereby obtaining the silver halide emulsion.

6. The method as claimed in claim 4, wherein the dual-implantation method is an equal speed dual implantation.

7. The method as claimed in claim 4, wherein the dual-implantation is performed at a temperature in the range from about 25 degrees Celsius to about 35 degrees Celsius for about 5 minutes to about 15 minutes.

8. The method as claimed in claim 1, further comprising a developing process to develop the irradiated silver particle circuit pattern using a reducible developing agent.

9. The method as claimed in claim 8, wherein the developing agent comprises hydroquinone.

10. The method as claimed in claim 8, wherein the developing agent further comprises a promoter selected from the group consisting of potassium carbonate, sodium carbonate, borax, sodium hydroxide and potassium hydroxide.

11. The method as claimed in claim 8, wherein the developing agent comprises methyl-p-aminophenol sulfate and sodium sulfite.

12. The method as claimed in claim 1, wherein the circuit pattern is formed on the surface of the substrate using an ink jet printing method.
